(19) United States
(12) Patent Application Publication
(10) Pub. No.: US 2015/0052602 A1
(43) Pub. Date: Feb. 19, 2015

(54) Electronic Apparatus and Password Input Method of Electronic Apparatus

(71) Applicant: Kabushiki Kaisha Toshiba, Tokyo (JP)

(72) Inventor: Tadashi Tsuji, Tachikawa-shi (JP)

(21) Appl. No.: 14/455,501

(22) Filed: Aug. 8, 2014

Related U.S. Application Data
(60) Provisional application No. 61/865,879, filed on Aug. 14, 2013.

(51) Int. Cl. G06F 21/36

(52) U.S. Cl. CPC G06F 21/36
USPC 726/19

(57) ABSTRACT

An electronic apparatus includes a display module, a touch panel, a password input receiving module and a password display module. The touch panel is provided overlaying on the display module. The password input receiving module receives a password input through the touch panel. The password display module moves and displays keys while inputting a password on a password entry screen on which a group of the keys for identifying a password to be input is displayed.

### CROSS-REFERENCE TO RELATED APPLICATIONS

This application claims the benefit of U.S. Provisional Application No. 61/865,879, filed Aug. 14, 2013, the entire contents of which are incorporated herein by reference.

### FIELD

An embodiment of the present invention relates to electronic apparatus and a method for inputting a password in the electronic apparatus.

### BACKGROUND

There has been a software (SW) keyboard technology which displays an image of a keyboard on a display device such as an LCD (Liquid Crystal Display), and outputs a key code to a program such as OS based on a user's operation input to the image of the keyboard.

On the other hand, when password input keys are arranged at a certain positions at the time of inputting a personal identification number at an ATM (automated teller machine), etc., the movement of fingers, being possibly subjected to sneak look at the time of inputting the password, makes it possible to infer the password. In order to prevent this drawback, the SW keyboard is employed to display the input keys in a random manner, which makes it difficult to guess the password from the movement of fingers. However, once the SW keyboard is displayed, the arrangement does not change until input of the password (four digits, for example) is completed.

More specifically, there has been a problem so far such that if the SW key arrangement displayed in a random manner is subjected to sneak look even for a moment, the password is eventually guessed from the movement of fingers inputting the password. There also has been a problem such that if the SW key arrangement is changed in a random manner for each input of password, a user will momentarily lose the visual contact with positions of keys to be pressed for the password, thereby deteriorate a user operability.

### BRIEF DESCRIPTION OF THE DRAWINGS

FIG. 1 is a configuration showing a structure of electronic apparatus according to an embodiment.

FIG. 2 is a configuration showing a system configuration of a computer according to an embodiment.

FIG. 3 is a configuration showing functional blocks of key input control program according to an embodiment.

FIGS. 4A and 4B are configurations showing an example of regularly moving keys of an SW keyboard of the embodiment.

FIG. 5 is a configuration showing an example of an entry screen on ATM for inputting a personal identification number according to the embodiment.

FIG. 6 is a configuration showing an example of authentication of personal identification by a smartphone/tablet according to the embodiment.

FIG. 7 is a configuration showing an example of a screen of displayable key list displayed on a display module according to an embodiment.

FIGS. 8A and 8B are configurations showing a variation of shape, size and direction of movement of keys.

FIG. 9 is a flowchart showing an example of input of a password according to an embodiment.

### DETAILED DESCRIPTION

According to one embodiment, an electronic apparatus includes a display module, a touch panel, a password input receiving module and a password display module. The touch panel is provided overlaying on the display module. The password input receiving module receives a password input through the touch panel. The password display module moves and displays keys while inputting a password on a password entry screen on which a group of the keys for identifying a password to be input is displayed.

Various Embodiments will be described hereinafter with reference to the accompanying drawings.

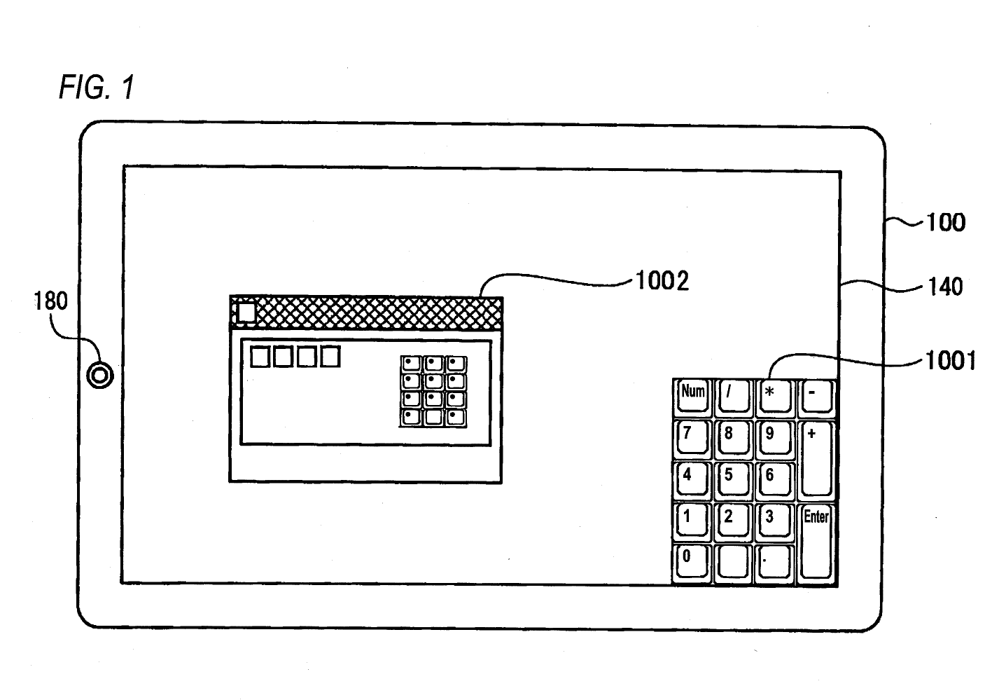

An embodiment will be described below with reference to FIGS. 1 to 9.

FIG. 1 is a configuration showing a structure of a computer 100 according to an embodiment of electric apparatus.

The computer 100 shown in FIG. 1 is a mobile terminal (such as a tablet terminal) which is provided with a display device 104 and a power supply button 180. The display device 140 is provided with a touch panel sensor which enables the input of positional coordinates by touching.

In the example shown in FIG. 1, the computer 100 makes it possible to display all the keys of full keyboard including numerical keys in a form of a software keyboard, as well as to display and operate a window. These will be described later in detail. Furthermore, the power supply button 180 is a button switch which is provided in the left of the display device 140 on the top surface of the computer 100, and receives the operation input for turning on/off the computer 100.

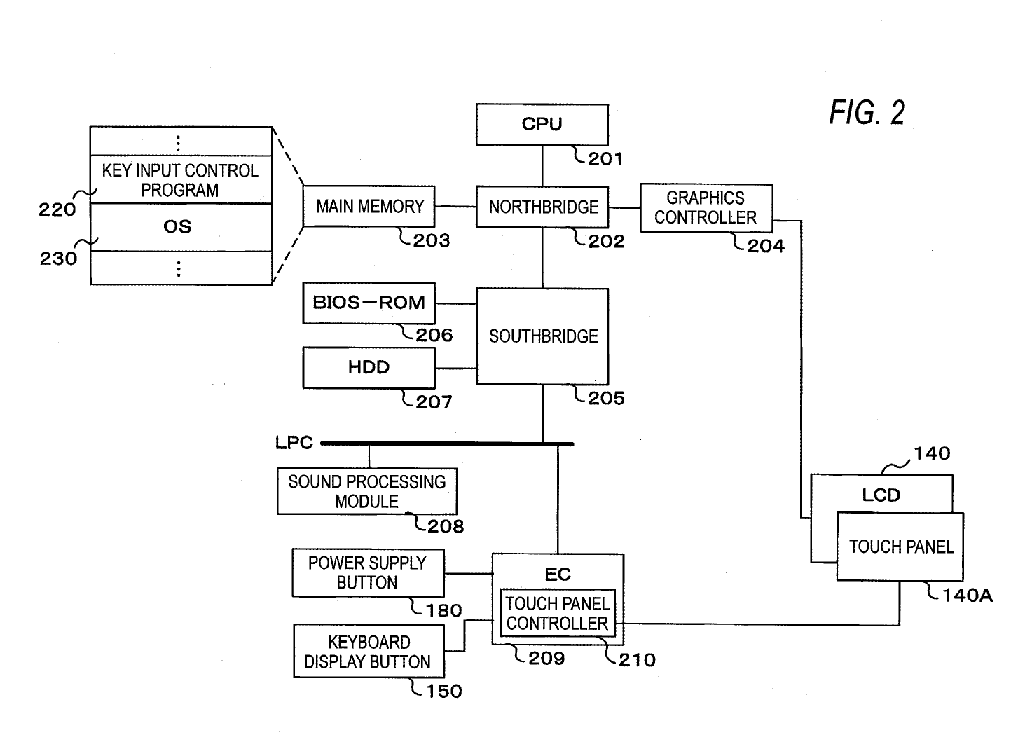

Then, the system configuration of the computer 100 will be described with reference to FIG. 2.

The computer 100 is provided with a CPU 201, a Northbridge 202, a main memory 203, a graphics controller 204, a Southbridge 205, a BIOS-ROM 206, a hard disk drive (HDD) 207, a sound processing module 208, an embedded controller 209, etc.

The CPU 201 is a processor provided for controlling the operation of the computer 100, and executes a variety of application programs such as an operating system (OS) 230 and a key input control program 220 which are read from the HDD 207 into the main memory 203.

Furthermore, the CPU 201 also has a function of executing a system BIOS (Basic Input Output System) stored in the BIOS-ROM 206, which is a program for controlling hardware of the computer 100.

The Northbridge 202 is a bridge device which provides a connection between a local bus of the CPU 201 and the Southbridge 205. The Northbridge 202 also contains a memory controller for providing the access control for the main memory 203.

The main memory 203 is a temporary storage area for reading OS and a variety of applications executed by the CPU 201. Programs, such as OS 230 and the key input control program 220, which are stored in the HDD 207 are read in the main memory 203.

The graphics controller 204 is a display controller for controlling an LCD 140 used as a display of the computer 100. Then, the graphics controller 204 executes the display processing (graphics computation processing) for rendering display data on a video memory (VRAM) based on rendering request input from through the Northbridge 202 the CPU 201. The storage area for storing the display data corresponding to a screen image to be displayed on the LCD 140 is allocated to the video memory.

The Southbridge 205 contains an IDE (Integrated Drive Electronics) controller or a Serial ATA controller for controlling the HDD 207.

The sound processing module 208 (not shown) applies the sound processing, such as digital conversion, noise removal, echo cancellation, to a voice signal input from a microphone, and then outputs it to the CPU 201. Furthermore, the sound processing module 208 outputs a voice signal generated by applying a sound processing such as sound synthesis under the control of the CPU 201 to a speaker so as to output sound from the speaker. In addition, the sound processing module 208 can generate voice signals differently depending on the touched key.

The embedded controller (EC) 209 has a function of turning on/off the computer 100 in response to the operation of the power supply button 180 by a user. Furthermore, the embedded controller (EC) 209 includes a touch panel controller 210 which controls a touch panel 140A provided on the LCD 140.

In addition, the touch panel 140A is configured to detect a touched area (touched position) on a touch panel (touch screen display) using resistance film method or capacitive method, for example.

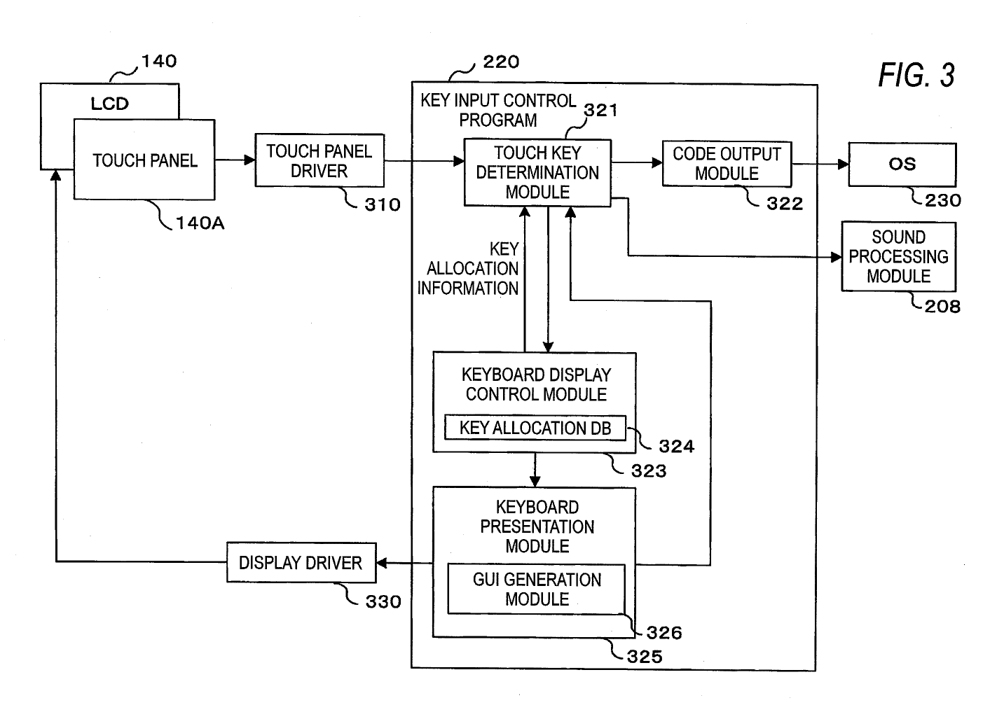

Next, the functional blocks of the key input control program 220 will be described with reference to FIG. 3.

The key input control program 220 is provided with a touch key determination module 321, a code output module 322, a keyboard display control module 323, and a keyboard presentation module 325.

The touch key determination module 321 receives touched area detection information input from a touch panel driver 310 contained in the touch panel controller 210 when the touch panel 140A receives a touch operation input to detect the touched area where the operation input has been done. In addition, the touched area detection information contains coordinate data indicating the touched area (touched position) on the touch panel 140A touched by an external member (such as fingers of a user, or a pen).

Then, the touch key determination module 321 determines which of keys is touched by a user based on the touched area detection information, window information input from the keyboard presentation module 325, and key allocation information input from the keyboard display control module 323.

More specifically, the touch key determination module 321 obtains the touched area detection information with regard to the coordinate information in the area on the touch panel 140A to which a touch operation is applied, and obtains window information which is the coordinate information with regard to the location and size and the like of a keyboard window displayed on the LCD 140, and key allocation information which is the coordinate information indicating which of keys is allocated to which of areas out of the areas on the window. Then, the touch key determination module 321 compares the coordinate information of the touched area detection information with the coordinate information of the window information and that of the key allocation information so as to determine to which of keys is subject to the input operation.

Here, when determining that the touch operation is applied to a key other than the display switch key of the keys of the software keyboard, the touch key determination module 321 outputs a notification regarding a key to which the touch operation is applied to the code output module 322, and also give the keyboard display control module 323 a notification regarding the key to which the touch operation input is applied.

Furthermore, when receiving a touch operation input to a key image of the software keyboard, the touch key determination module 321 gives the sound processing module 208 instructions to generate voice signals differently depending on the operated key if necessary.

When receiving a notification from the touch key determination module 321 regarding the key to which the touch operation input is applied, the code output module 322 outputs a code corresponding to the key concerned to the OS 230.

Furthermore, the keyboard display control module 323 has a key allocation database 324. Here, the key allocation database 324 is a database about the key allocation information indicating by coordinate data and the like that which of keys is arranged at which of locations on the keyboard window displayed on the LCD 140. Then, the key allocation information indicates the location of a key by the coordinate value regarding upper left or lower left of a keyboard window as a reference point, for example. The coordinate value may be a relative coordinate value that changes depending on the location of keyboard window. In addition, when the size of the keyboard window is changed, the coordinate value can be changed corresponding to the size.

The keyboard presentation module 325 displays a software keyboard on the LCD 140 through a display driver 330. Furthermore, the keyboard presentation module 325 is provided with a GUI generation module 326. When receiving an instruction of switching the display of keyboard image from the keyboard display control module 323, the GUI generation module 326 generates a keyboard image based on the instruction. Then, the keyboard presentation module 325 outputs the keyboard window including the generated keyboard image to the display driver 330 in the touch panel controller 210, thereby displaying the keyboard on the LCD 140.

In addition, the keyboard presentation module 325 outputs the keyboard window to the display driver 330, and also outputs the window information regarding the position and size and the like of the keyboard window on the LCD 140 to the touch key determination module 321. In addition, the keyboard presentation module 325 outputs the window information when the displayed position of the keyboard window changes, for example.

Then, the display driver 330 displays the keyboard window on the LCD 140 when receiving an input of the keyboard window from the keyboard presentation module 325.

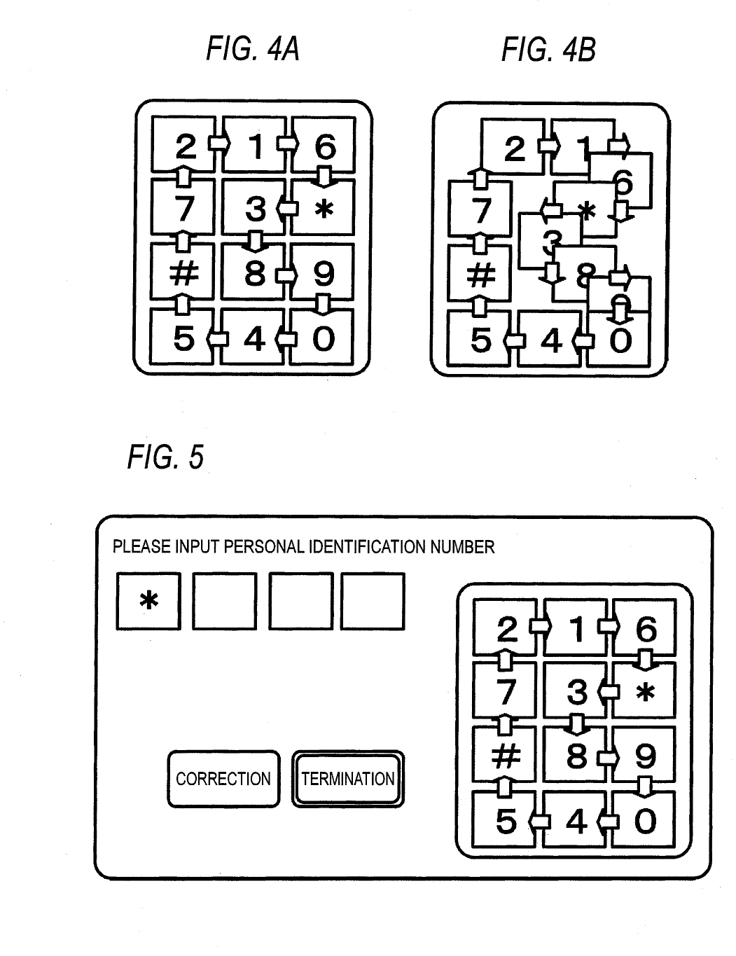

Subsequently, the keyboard displayed by the computer 100 according to the present embodiment will be described with reference to FIG. 4.

Then, FIG. 4 is a configuration showing an example of regularly moving keys of the SW keyboard. The example shows that the keys arranged in a random manner slowly moves (rotates) in a random direction (vertically and horizontally) so that a person who inputs a password can follow the keys with his/her eyes. For example, “2” key follows “1” key in the direction of arrow in the state of FIG. 4A when a user presses any one of twelve keys. The following may occur at the same time in each key, or may be the operation which makes a partial movement as shown in FIG. 4B. In FIG. 4B, the operation travels from “2” key to “9” key. Security increases while keys overlay on each other.

The arrow may be configured to be visible. While it is preferable to be invisible in order to increase the security, it may be possible to set the arrow to be visible or invisible depending on whether or not it is easy for a user to grasp the next stationed position when he/she is not accustomed to it. Furthermore, it may be possible to set the movement to rotate in the opposite direction.

Furthermore, it may be possible to set the speed of change of the key arrangement by a user.

FIG. 5 is a configuration showing an example of an entry screen of ATM of a bank for inputting a personal identification number. The arrangement and movement of the SW keyboard are same as those in FIG. 4.

An aspect is shown in which an operation screen shows an input prompt of “PLEASE INPUT PERSONAL IDENTIFICATION NUMBER”. The personal identification number has four digits and the case is shown where a first digit has been input just now. After that, the keys slowly move by one step.

In addition, as the specification, correction is made by pressing a correction button below to move by one digit antecedent thereto. As the specification, it is terminated when four digits are input and a termination button is pressed.

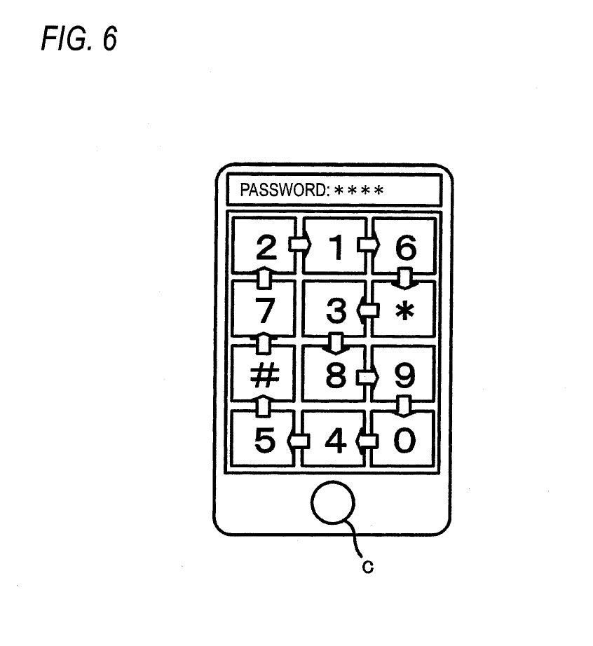

FIG. 6 is a configuration showing an example of authentication of personal identification by a smartphone/tablet. The arrangement and movement of the SW keyboard are same as those in FIG. 4.

An aspect is shown in which the window at the upper portion shows an input prompt of “PASSWORD:”. The case is shown where the number of digits of personal identification number is not clearly indicated and the input has been done up till fourth digit. After that, the keys slowly move by one more step. As the specification, correction is made by pressing a correction button C below to move by one digit antecedent thereto. As the specification, it is automatically terminated when the necessary number of digits is input. A function module (not shown) corresponding to the sound processing module 208 may be set to make different sounds between the case where the key is pressed and the case where the correction button C is pressed, or may be set to make no sound.

Also, the OS 230 itself may execute the personal authentification when the computer 100 is activated by the power supply button 180.

Then, the SW keyboard may be a type of a numerical keypad 1001 (actually, the module including ten numbers, “.” and (space), or the module further including “Num”, “/” and “*” added thereto). Here, it is possible to prevent the keys from overlaying on each other as in FIG. 4B if the configuration with excluding (hiding) a space key is employed to move the keys sequentially relying on the hole coming from the structure. Preventing the keys from overlaying on each other makes it easier for a user to follow the keys with his/her eyes. Furthermore, if large display size annoys a user, it may be configured so that an image-like object shown in FIG. 5 is displayed in a small window 1002 in FIG. 1, for example.

Furthermore, the SW keyboard may be an alphabet type like the one used in PC.

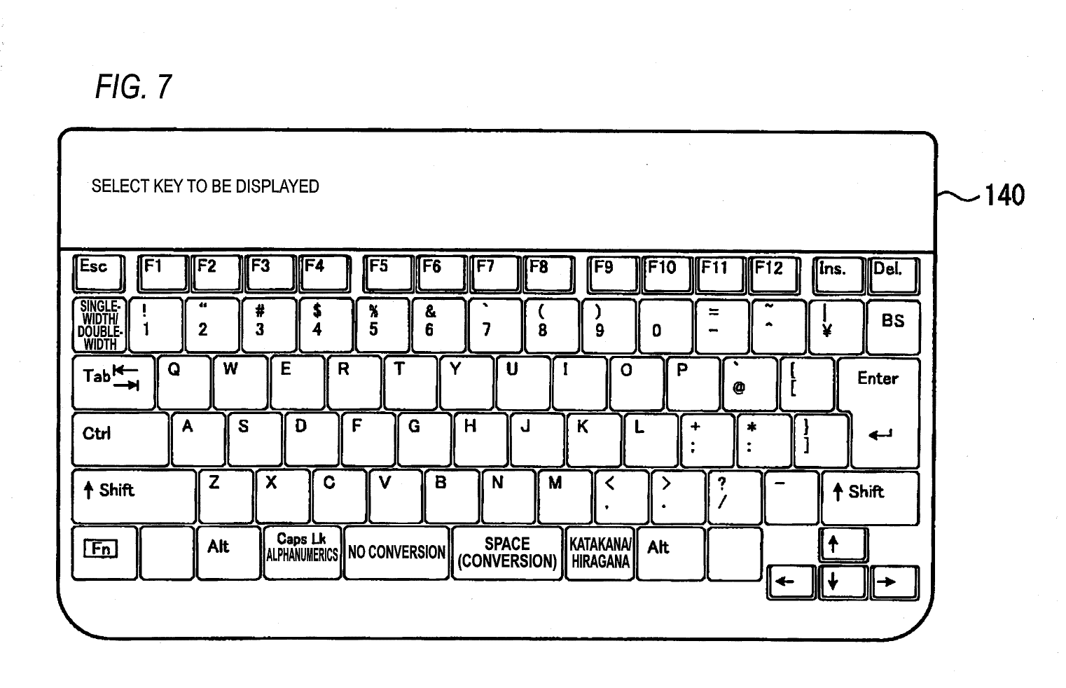

For example, FIG. 7 is a configuration showing an example of a screen of displayable key list displayed by the key input control program 220 according to the present embodiment. The touch key determination module 321 may be configured to receive the selection of displaying/hiding for each key by the operation from a user in order to display the keys from the list shown in FIG. 7 on the display device 140.

Then, the keyboard display control module 323 configures a software keyboard based on the selection from the list shown in FIG. 7 when receiving a massage indicating the display of software keyboard. More specifically, the keyboard display control module 323 causes the keyboard presentation module 325 to display the software keyboard configured by keys selected from the key list shown in FIG. 7 to be displayed as software keyboard.

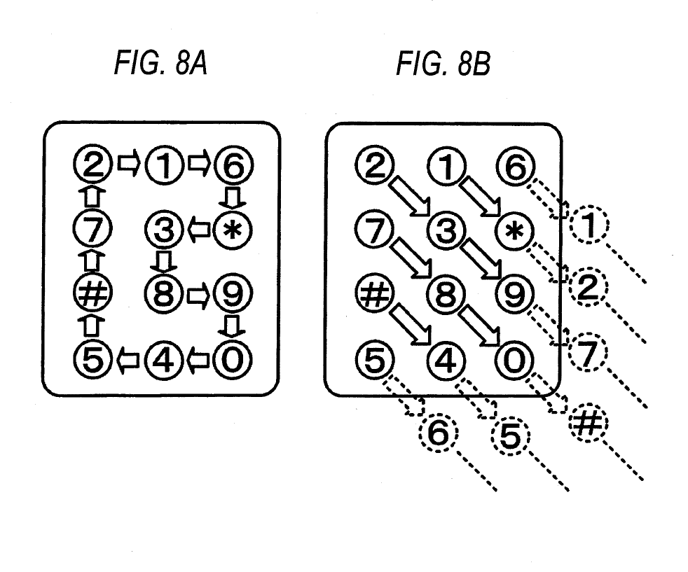

FIG. 8 is a configuration showing a variation of shape, size and direction of movement of keys. FIG. 8A is an example in which overlaying as in FIG. 4B is prevented in shape and size of keys. Preventing the keys from overlaying on each other makes it easier for a user to follow the keys with his/her eyes.

Still further, FIG. 8B is an example in which the movement is created in the direction other than the vertical and horizontal directions, the conception of which is that each key obliquely follows after the other.

For example, “2” key takes the position of “3” key, and “*” key takes the position of “2” key, so that they follows after the other in the direction of arrow when a user presses any of twelve keys. It may be possible for a user to select the movements in the oblique, vertical and horizontal directions as he/she desires.

Still further, it is possible to configure the key arrangement so as to be changed in a random manner at the time of redisplaying. When the number of keys is small, it is expected to be configured so that a user is not confused very much and the security becomes higher.

Furthermore, it may be possible to set the keys of the SW keyboard to be hidden once and then displayed again for each input of characters. When the keys are hidden, it becomes difficult to look at the keys out of the corner of a person's eye, thereby increasing the security.

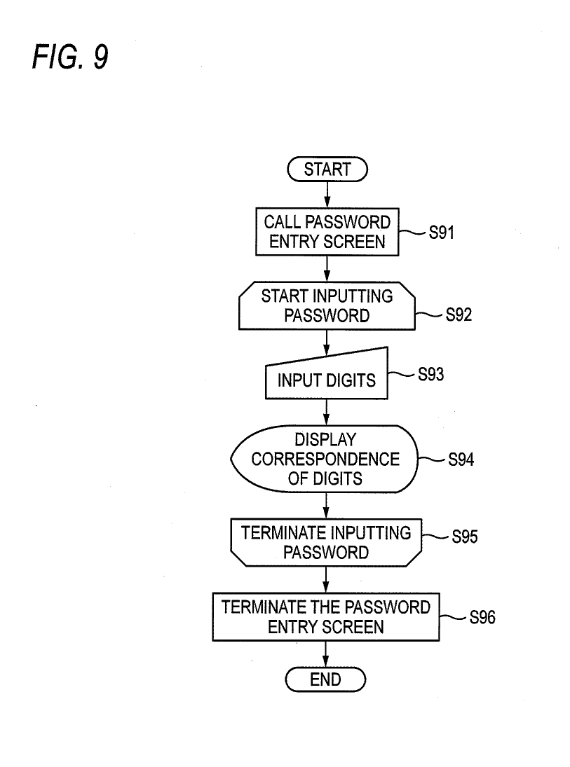

FIG. 9 is a flowchart showing an example of the input of a password described above.
Step S91: In general, the OS 230 executes calling of a password entry screen and activation of the key input control program 220 through an application which requires input of a password.
Step S92: A user starts inputting the password.
Step S93: A user inputs digits.
Step S94: The key input control program 220 notifies an input code to the OS 230 to move the keys on the LCD 140. As the display corresponding to digits, the key input control program 220 further displays by * symbols to what number of digits the input has been done.
Step S95: When the necessary number of digits is input, the input of password is terminated.
Step S96: The application software described above becomes active to execute the termination of the password entry screen, and the OS 230 executes the termination of the key input control program 220.

In order to solve the problem described above, the present embodiment has achieved both the usability and the randomness of key display at the same time.

In addition, the present invention is not limited to the embodiments described above, but also can be implemented in other various modifications within the range not departing from the gist thereof.

Furthermore, the appropriate combination of a plurality of components disclosed in the embodiment described above can form a variety of inventions. For example, some components may be removed from all the components shown in the embodiment. Furthermore, components associated with different embodiments may be combined appropriately.

What is claimed is:

1. An electronic apparatus, comprising:
a display module;
a touch panel configured to be provided overlaying on the display module;
a password input receiving module configured to receive a password input through the touch panel; and
a password display module configured to move and to display keys while inputting a password on a password entry screen on which a group of the keys for identifying a password to be input is displayed.

2. The electronic apparatus of claim 1, wherein the password display module moves the group of the keys by rotating vertically and horizontally.

3. The electronic apparatus of claim 1, wherein the password display module moves the group of the keys in an oblique direction.

4. The electronic apparatus of claim 1, wherein the password display module moves the group of the keys so as to overlap one key in the group of the keys with another key in the group of the keys each other while moving the group of the keys.

5. The electronic apparatus of claim 1, wherein the password display module moves the group of the keys without overlap between one key in the group of the keys and another key in the group of the keys while moving the group of the keys.

6. The electronic apparatus of claim 1, wherein the password display module makes the group of the keys to be hidden temporarily.

7. The electronic apparatus of claim 1, wherein the password display module changes a speed of moving the keys based on a predetermined instruction.

8. A method for inputting a password to electronic apparatus, comprising:
calling a password entry screen;
recognizing an input of digits of the password by using a group of keys on the password entry screen; and
moving the group of the keys according to at least one input of the digits.
